(19) United States
(12) Patent Application Publication
(10) Pub. No.: US 2022/0114447 A1
(43) Pub. Date: Apr. 14, 2022

(54) ADAPTIVE TUNING PARAMETERS FOR A CLASSIFICATION NEURAL NETWORK

(71) Applicant: AONDEVICES, INC., Irvine, CA (US)

(72) Inventors: Mouna Elkhatib, Irvine, CA (US); Adil Benyassine, Irvine, CA (US); Aruna Vittal, Irvine, CA (US); Eli Uc, Irvine, CA (US); Daniel Schoch, Irvine, CA (US)

(21) Appl. No.: 17/450,398

(22) Filed: Oct. 8, 2021

Related U.S. Application Data
(60) Provisional application No. 63/089,299, filed on Oct. 8, 2020.

(51) Int. Cl. G06N 3/08; G10L 25/30

(52) U.S. Cl. CPC G06N 3/08; G10L 25/30

(57) ABSTRACT

A neural network parameter tuner has an auxiliary neural network receptive to an input data stream with signal components and noise components associated with ambient conditions. An ambient classification value is periodically derived from the input data stream based upon the noise components detected therein. A primary neural network receptive to the input data stream classifies the input data stream based upon an assigned detection threshold corresponding to the ambient classification value.

### CROSS-REFERENCE TO RELATED APPLICATIONS

This application relates to and claims the benefit of U.S. Provisional Application No. 63/089,299, filed Oct. 8, 2020 and entitled “ADAPTIVE TUNING PARAMETERS FOR A CLASSIFICATION NEURAL NETWORK”, the disclosure of which is wholly incorporated by reference in its entirety herein.

### STATEMENT RE: FEDERALLY SPONSORED RESEARCH/DEVELOPMENT

Not Applicable

### BACKGROUND

### 1. Technical Field

The present disclosure is directed to neural networks and sensor signal detection, and more specifically to adaptive tuning parameters for a classification neural network.

### 2. Related Art

Conventional data processor devices have the capability of performing numerous operations in a short period of time, and so are well suited for capturing real-time signals from an environment and converting the same to a stream of digital data. For instance, audio signal captured by a microphone and transduced to an analog electrical signal thereby may be converted to a sequence of data that correspond to numerical voltage values of such analog electrical signal at discrete time intervals. These digital audio data streams may be readily transferred from one device to another, replayed, and manipulated as desired with digital signal processing algorithms. Deriving further meaning from such digital audio data, such as recognizing uttered words captured in the recorded audio, requires further processing.

Artificial neural networks is one possible modality that has been implemented with success for not only speech recognition, but a wide range of digitally captured real-world information such as static images, moving images (video), and so on. In the most basic form, a neural network is understood to be a set of interconnected information processing nodes organized as an input layer, one or more hidden layers, and an output layer. Each node is defined by the input thereto, weights applied to that input, a threshold to activate the next node based on the input/weight, and its output. A wide network of such nodes can be configured and trained to recognize the higher-level content from an input of the underlying data.

Such artificial intelligence deep learning neural networks utilized for command/keyword spotting based on classification detection are understood to achieve superior performance over conventional Hidden Markov Model (HMM) based solutions. Deep learning-based recognition algorithms are configured to maximize accuracy and/or minimize log-likelihood loss, though further performance improvements are possible with successful class detection. The output of the neural network is a probability score that quantifies the likelihood of the correct class being detected. The final classification decision is based upon a selection of the class that scores the highest probability. In order to confirm the classification decision, a secondary test may be performed where the selected class must exceed a preset detection threshold T. This secondary test is performed to strike an appropriate balance between a high detection rate/hit rate, and a low false alarm detection rate.

In the context of speech recognition, class detection may be performed in a wide range of varying acoustic environments that have different mixes of ambient noise, background music, reverberant rooms, and so forth. Setting a preset detection threshold (T) that works under all conditions is challenging and presetting a detection threshold to a single value in an attempt to cover varying ambient conditions is a suboptimal solution. Accordingly, there is a need in the art for adaptive tuning parameters for a classification neural network.

### BRIEF SUMMARY

In accordance with the embodiments of the present disclosure, a neural network is configured to detect a class and the operating ambient conditions to adaptively set the detection threshold (T), as well as other parameters of the neural network. The value of the detection threshold (T) is understood to be lowered or increased depending on the operating ambient conditions. In order to maximize the detection rate of the class while minimizing false detections, the detection threshold (T) may be set to a higher value if ambient noise is weak, while the detection threshold (T) may be set to a lower value for adverse ambient conditions.

According to one embodiment of the present disclosure, there may be a method for adaptively tuning parameters for a neural network. The method may include receiving an input data stream that has signal components and noise components associated with ambient conditions. There may be a step of feeding the input data stream to a neural network, as well as deriving, with the neural network, an ambient classification value from the input data stream based upon detected noise components therein. The method may also include assigning a detection threshold for the input data stream from the derived ambient classification value. There may also be a step of classifying, with the neural network, the signal components in the input data stream based upon the assigned detection threshold.

In another embodiment of the present disclosure, there may be a method for adaptively tuning parameters for a neural network. The method may include receiving an input data stream having signal components and noise components associated with ambient conditions. The method may also include feeding the input data stream to a primary neural network and an auxiliary neural network. Furthermore, the method may include deriving, with the auxiliary neural network, an ambient classification value from the input data steam based upon detected noise components therein. There may additionally be a step of assigning a detection threshold for the input data stream from the derived ambient classification value. There may also be a step of classifying, with the primary neural network, the signal components in the input data stream based upon the assigned detection threshold.

Still another embodiment of the present disclosure may be a neural network parameter tuner. The neural network parameter tuner may include an auxiliary neural network receptive to an input data stream with signal components and noise components associated with ambient conditions. The auxiliary neural network may periodically derive an ambient classification value from the input data stream based upon the noise components detected therein. The neural network parameter tuner may include a primary neural network receptive to the input data stream. The signal components therein may be classified by the primary neural network based upon an assigned detection threshold corresponding to the ambient classification value.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram illustrating an exemplary device on which embodiments of the present disclosure may be implemented;

FIG. 2 is block diagram illustrating the components of a single neural network implementation of a system for adaptively tuning parameters for a classification neural network;

FIG. 3 is a flowchart showing the steps of a method for adaptively tuning parameters for a neural network according to a first embodiment of the present disclosure;

FIG. 4 is a block diagram illustrating the components of a two-part neural network implementation of the system for adaptively tuning parameters for a classification neural network; and

FIG. 5 is a flowchart showing the steps of a method for adaptively tuning parameters for a neural network according to a second embodiment of the present disclosure.

### DETAILED DESCRIPTION

The detailed description set forth below in connection with the appended drawings is intended as a description of the several presently contemplated embodiments of adaptively tuning parameters for a classification neural network. This description is not intended to represent the only form in which the embodiments of the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

The systems and methods of the present disclosure will be described in the context of speech/voice or the like audio processing applications. It is to be understood, however, that the embodiments of the present disclosure may be adapted to any other system in which a higher level meaning is to be derived from a signal captured from the environment and digitized, in particular where a classification neural network is utilized to determine the class of the information contained within a raw signal. In this context, the term class refers to any general category of sensor data that is to be detected, such as a keyword, a voice command, sound event, or any acoustic scene from an audio signal captured by a microphone. The systems and methods of the present disclosure may be adapted motion sensor data, image sensor data, or any other sensor data that has digitized/quantized a real-world input.

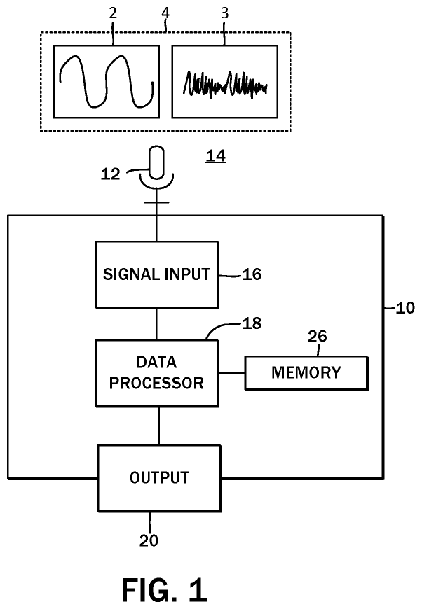

With reference to the block diagram of FIG. 1, various embodiments of systems and methods for adaptively tuning parameters for a classification neural network may be implemented in a device 10. By way of example and not of limitation, the device 10 may be used for processing speech and performing further data processing operations in response to commands detected in the inputted audio. To this end, the device 10 may include a signal input device 12 or microphone, which captures acoustic waves propagating through a surrounding environment 14 and converts those acoustic waves to corresponding analog electronic signals or waveforms. These acoustic waves may contain information or a signal of interest, referred to generally as signal components 2, along with background noise, extraneous noise, and so on referred to generally as noise components 3. In order to process the electronic signals, there may be a signal input processor 16. In its most basic form, the signal input processor 16 may be an analog-to-digital converter (ADC) that converts discrete voltage values of the analog signal to equivalent numeric or digitally represented numbers at set sampling intervals. The resulting data stream is understood to include the same signal components 2 and the noise components 3, which is represented in FIG. 1 as an input data stream 4.

Again, the present disclosure sets forth various embodiments in the context of an audio or speech processing device 10, but other embodiments may be adapted to processing information in other forms. Thus, those having ordinary skill in the art will readily appreciate corresponding equivalents to the signal input device 12 and the signal input processor 16, to the extent such components are utilized in the context of such alternative applications.

In further detail, the device 10 includes a data processor 18 that can be programmed with instructions to execute various operations. The data processor 18 may be connected to the signal input processor 16 to receive the converted digital audio stream data from the captured audio and apply various operations thereto. As will be described more fully below, the data processor 18 may be programmed with instructions to implement one or more neural networks that can detect a class or classes of signal components as distinguished from the noise components.

Generally, the results of the operations performed by the data processor 18 may be provided to an output 20. In the context of one exemplary embodiment of a voice-activated assistant device, the data processor 18 may be further programmed to recognize commands issued to the device 10 by a human speaker, execute those commands, obtain the results of those commands, and announce the results to the output 20. In other embodiments, the output 20 may be a display device that visually presents the results. Still further, the output 20 may connect to a secondary device, either locally or via one or more networks, to relay the results from the data processor 18 for further use by such secondary remote devices.

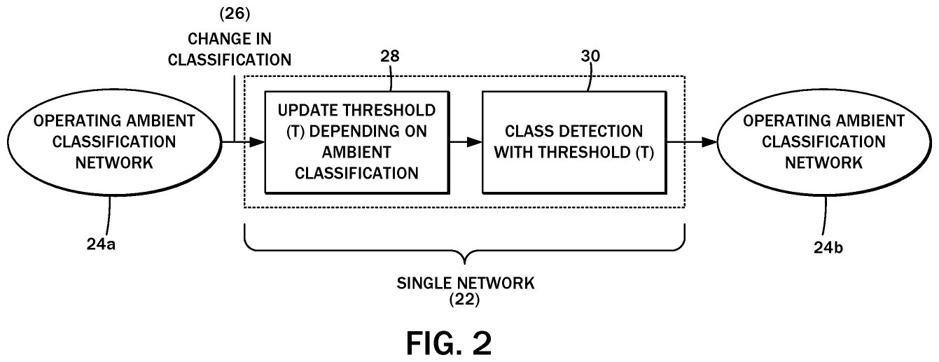

With reference to the block diagram of FIG. 2, one embodiment of the disclosure contemplates a single neural network 22 that detects the class of the input signal and the operating ambient conditions to optimally set the detection threshold (T). A classification task typically involves computing a probability metric and compared to such detection threshold to assert that the intended class, e.g., a command/keyword was indeed correctly detected. In further detail, in a block 24a, the operating ambient condition is detected and classified. This may take place on a periodic basis as deemed suitable for the application by those having ordinary skill in the art.

According to a preferred, though optional environment of the audio processing system, this may comprise detecting the ambient conditions and specifically the noise components 3 of the input data stream 4. The noise component 3 may be given an ambient classification value that corresponds to one of several predetermined classes, such as a silence condition, a stationary noise condition (e.g., a fan noise, an air conditioning system hum, an running generator noise, etc.) or a non-stationary noise condition (e.g., background conversation). The embodiments of the present disclosure contemplate each such class having an associated detection threshold (T).

Initially, or at the detection of a change 26 in the ambient classification value, the neural network 22 has a block 28 in which the detection threshold (T) is updated in response. This detection threshold (T) is provided to a block 30 that proceeds to class detection of the input data stream 4. With the neural network 22 setting the detection threshold (T) to its optimal value for a given operating ambient condition, the class detection on the input data stream 4 is contemplated to be with minimal false detection. The neural network 22 then continues to monitor the operating ambient condition for changes in a subsequent block 24b.

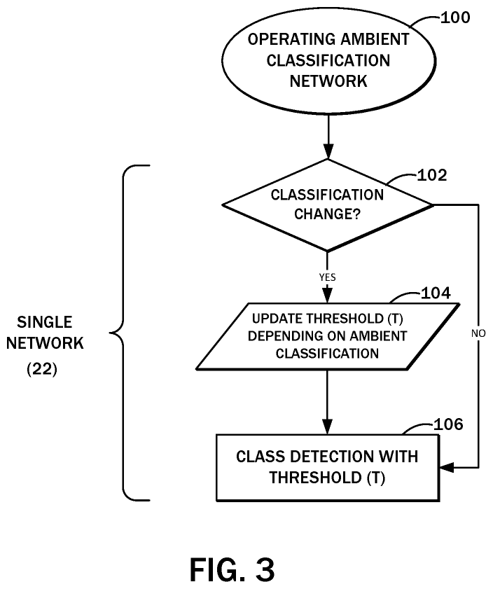

Referring to the flowchart of FIG. 3, the embodiment of the disclosure that is the method for adaptively tuning parameters for the neural network 22 begins at a step 100 with the operating ambient classification network. In a decision block 102, it is determined whether there has been a classification change as to the received input data stream 4, particularly with regard to the noise components 3 thereof. More particularly, the neural network 22 derives an ambient classification value from the input data stream 4 based upon the detected noise components 3. Thereafter, in a step 104, the detection threshold (T) is updated based upon the derived ambient classification value from the previous step. The neural network 22 proceeds to class detection in relation to the input data stream 4 per step 106, utilizing the newly set detection threshold (T). If in the decision block 102 there was no change in the ambient classification value, then the method proceeds immediately to the step 106. Again, in this embodiment, both the determination of the suitable detection threshold (T) and the class detection is performed by the single neural network 22.

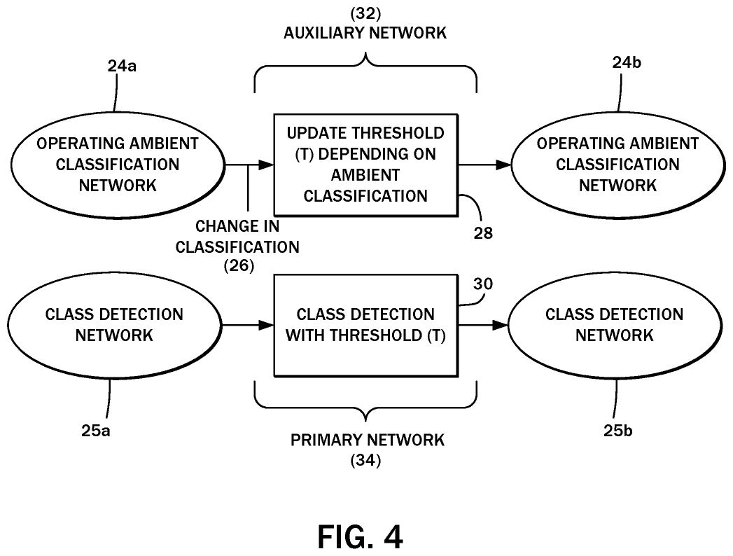

According to another embodiment of the present disclosure, two neural networks are operated in collaboration together. Referring to the block diagram of FIG. 4, there is an auxiliary network 32 and a primary network 34, with the auxiliary network 32 being dedicated to detecting operating ambient conditions and the primary network 34 being dedicated to class detection. The auxiliary network 32 is envisioned to provide the primary network 34 with the optimal detection threshold (T) for a given input data stream 4.

Again, in the block 24a, the operating ambient condition is detected and classified. This may take place on a periodic basis, and is performed by the auxiliary network 32. As in the first, single-network embodiment described above, in the block 28, initially or at the detection of a change 26 in the ambient classification value, the detection threshold (T) is updated in response. This detection threshold (T) is provided to the block 30 that is instead implemented by the primary network 34, which proceed to class detection of the input data stream 4. The auxiliary network 32 then continues to monitor the operating ambient condition for changes in a subsequent block 24b.

The class detection of the input data stream 4 proceeds independently of the updating of the detection threshold, as it is being performed by the primary network 34. In this regard, prior to being provided with the updated detection threshold (T), there is an initial state of block 25a of the class detection network operating. Once the detection threshold (T) is updated in the block 30 by way of the block 28, the process continues with a subsequent state of block 25b of the same class detection network operating.

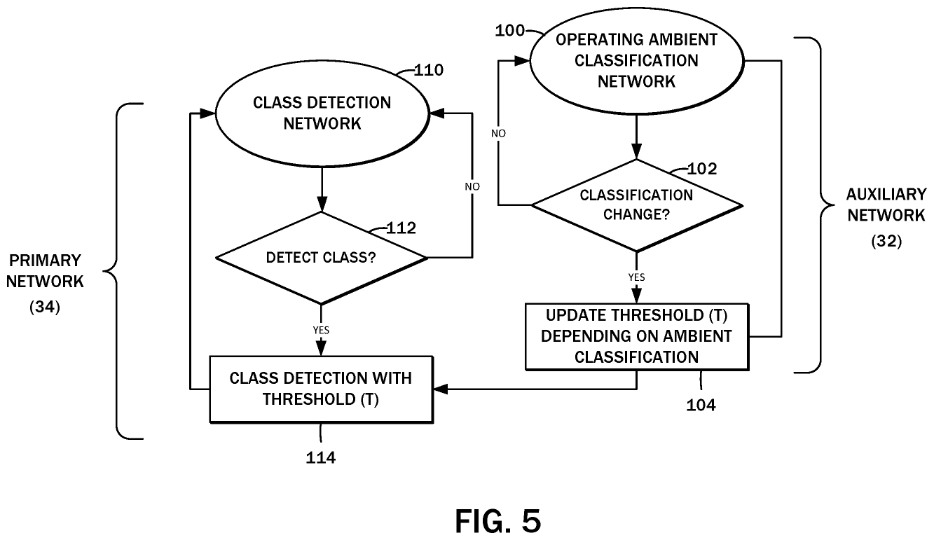

The flowchart of FIG. 5 illustrates an embodiment of the disclosure that is the method for adaptively tuning parameters utilizing the auxiliary network 32 and the primary network 34. The steps involving the auxiliary network 32 and the primary network 34 take place largely independent of each other, except for the auxiliary network 32 providing an updated detection threshold (T) to the primary network 34.

As for the steps for the auxiliary network 32, the method begins with the step 100 of the operating ambient classification network. In a decision block 102, it is determined whether there has been a classification change as to the received input data stream 4. The auxiliary network 32 derives an ambient classification value from the input data stream 4 based upon the detected noise components 3. Thereafter, in a step 104, the detection threshold (T) Is updated based upon the derived ambient classification value. If no change is detected, the method returns to the step 100 of the operating ambient classification network.

As to the steps for the primary network 34, the method begins with a step 110 of the class detection network. In a decision block 112, the detection of the class of a predetermined part of the input data stream 4 take place. If the class is not detected, the method returns to the step 110, but if there is, the method proceeds to a step 114 to detect the class utilizing the newly set detection threshold (T) provided by the auxiliary network 32. Thus, in this embodiment, the determination of the suitable detection threshold (T) is performed by the auxiliary network 32, while the class detection is performed by the primary network 34.

The particulars shown herein are by way of example and for purposes of illustrative discussion of the embodiments of low power, multi-stage selectable neural network suppression and are presented in the cause of providing what is believed to be the most useful and readily understood description of the principles and conceptual aspects. In this regard, no attempt is made to show details with more particularity than is necessary, the description taken with the drawings making apparent to those skilled in the art how the several forms of the present disclosure may be embodied in practice.

What is claimed is:

1. A method for adaptively tuning parameters for a neural network, comprising:
receiving an input data stream including signal components and noise components associated with ambient conditions;
feeding the input data stream to a neural network;
deriving, with the neural network, an ambient classification value from the input data stream based upon detected noise components therein;
assigning a detection threshold for the input data stream from the derived ambient classification value; and
classifying, with the neural network, the signal components in the input data stream based upon the assigned detection threshold.

2. The method of claim 1, further comprising:
deriving, with the neural network, a subsequent ambient classification value from a different part of the input data stream based upon detected noise components therein;
updating the detection threshold for the input data stream for the subsequently derived ambient classification value.

3. The method of claim 2, further comprising reclassifying, with the network, the signal components in the input data stream based upon the assigned updated detection threshold.

4. The method of claim 1, wherein the input data stream is derived from readings from a sensor device converted to digital data.

5. The method of claim 4, wherein the input data stream is representative of audio, the sensor device being a microphone.

6. The method of claim 1, wherein the neural network is a classification neural network.

7. A method for adaptively tuning parameters for a neural network, comprising:
receiving an input data stream including signal components and noise components associated with ambient conditions;
feeding the input data stream to a primary neural network and an auxiliary neural network;
deriving, with the auxiliary neural network, an ambient classification value from the input data steam based upon detected noise components therein;
assigning a detection threshold for the input data stream from the derived ambient classification value; and
classifying, with the primary neural network, the signal components in the input data stream based upon the assigned detection threshold.

8. The method of claim 7, further comprising:
deriving, with the auxiliary neural network, a subsequent ambient classification value from a different part of the input data stream based upon detected noise components therein; and
updating the detection threshold for the input data stream for the subsequently derived ambient classification value.

9. The method of claim 8, further comprising:
reclassifying, with the primary network, the signal components in the input data stream based upon the assigned updated detection threshold.

10. The method of claim 7, wherein the input data stream is derived from readings from a sensor device converted to digital data.

11. The method of claim 10, wherein the input data stream is representative of audio, the sensor device being a microphone.

12. The method of claim 7, wherein the neural network is a classification neural network.

13. A neural network parameter tuner, comprising:
an auxiliary neural network receptive to an input data stream with signal components and noise components associated with ambient conditions, the auxiliary neural network periodically deriving an ambient classification value from the input data stream based upon the noise components detected therein; and
a primary neural network receptive to the input data stream, the signal components therein being classified by the primary neural network based upon an assigned detection threshold corresponding to the ambient classification value.

14. The neural network parameter tuner of claim 13, wherein the auxiliary neural network derives a subsequent ambient classification value from a different part of the input data stream based upon detected noise components therein.

15. The neural network parameter tuner of claim 14, wherein the signal components of the different part of the input data stream are re-classified based upon the subsequently derived ambient classification value.

16. The neural network parameter tuner of claim 13, further comprising:
an input device feeding the input data stream to the auxiliary neural network and the primary neural network.

17. The neural network parameter tuner of claim 16, wherein the input device is an audio transducer.

18. The neural network parameter tuner of claim 13, wherein the primary neural network is a classification neural network.
